(19) United States
(12) Patent Application Publication
(10) Pub. No.: US 2017/0071136 A1
(43) Pub. Date: Mar. 16, 2017

(54) Tree Hydrating Device

(71) Applicant: Todd Andrews, Fairfax, VA (US)

(72) Inventor: Todd Andrews, Fairfax, VA (US)

(21) Appl. No.: 15/063,910

(22) Filed: Mar. 8, 2016

Related U.S. Application Data
(60) Provisional application No. 62/218,154, filed on Sep. 14, 2015.

(51) Int. Cl. A01G 7/06

(52) U.S. Cl. CPC A01G 7/06

(57) ABSTRACT

A tree hydrating device for providing water to a live or cut tree. The tree hydrating device includes a pouch having an interior volume that can receive and store fluid. The lower end of the pouch includes an opening for connection to a flexible, elongated tube. A second end of the elongated tube is removably securable to a tap. The tap includes a stem for engaging the elongated tube and a threaded exterior so that it can be inserted into the trunk of a tree and securely positioned therein. Once the tap is inserted, a user can connect the second end of the tube to the tap so that fluid is provided from the pouch, through the elongated tube, and into the tree under the force of gravity. In this way, the tree is provided with constant hydration.

### CROSS REFERENCE TO RELATED APPLICATION

This application claims the benefit of U.S. Provisional Application No. 62/218,154 filed on Sep. 14, 2015. The above identified patent application is herein incorporated by reference in its entirety to provide continuity of disclosure.

### BACKGROUND OF THE INVENTION

Field of the Invention

The present invention relates to tree hydrating devices. More specifically, the present invention provides a tree hydrating device comprising a pouch in which a hydrating fluid is stored, wherein an elongated tube extends from the pouch and includes a tap on an end thereof that can be inserted into an opening drilled in the trunk of a tree in order to supply the fluid directly thereto.

It is important to keep both live and cut trees hydrated. Cut trees, such as Christmas trees, can quickly dry out if they are not continuously watered. If the tree dries out, it will shed its leaves or needles, creating a mess. Further, the dry tree is a potential fire hazard. While many people water a tree from the base thereof, the water can become stagnant and the water may not be properly absorbed through the base of the trunk of the three. Further, it can be inconvenient for the user to change the water located in a basin at the base of the tree as the user must kneel down and reach underneath the tree towards the trunk thereof.

Live trees must also be hydrated so that they can grow properly and maintain proper health. If the tree is not hydrated, its growth may slow and the tree is at increased risk for damage by insects or disease. Many people water live trees, such as in an orchard or tree farm, by distributing water and fertilizer to the roots of the trees. However, not all of this water reaches the roots of the trees and as a result much of this water is wasted. Further, the run-off water often contains fertilizer which may pollute nearby rivers or streams. Thus, the run-off is wasteful and may create an environmental hazard. Additionally, this method of watering results in the trees only occasionally receiving water rather than having a constant source of water available. Such periodic watering may be particularly undesirable in hot or arid climates that have low rainfall where trees need a more constant source of hydration.

Devices have been disclosed in the prior art that relate to tree watering devices. These include devices that have been patented and published in patent application publications. Some devices in the prior art relate to tree injecting systems, such as U.S. Pat. No. 3,286,401, U.S. Pat. No. 6,405,480, U.S. Pat. No. 4,989,366, and U.S. Pat. No. 5,699,635. Other devices relate to tree watering devices, such as U.S. Published Patent Application Number 2005/0204617 and U.S. Pat. No. 6,167,651.

These prior art devices have several known drawbacks. The devices in the prior art relate to devices that are used to provide fluid to a tree. However, such devices utilize pumps and pressurized fluids for providing fluid to the tree, which can be costly and inefficient for users that must provide hydration to a large number of trees. The devices in the prior art fail to provide a tree hydrating device that utilizes gravity to supply fluid to a tree, and such devices do not include a tap for insertion into the trunk of the tree.

In light of the devices disclosed in the prior art, it is submitted that the present invention substantially diverges in design elements from the prior art and consequently it is clear that there is a need in the art for an improvement to existing tree hydrating devices. In this regard the instant invention substantially fulfills these needs.

### SUMMARY OF THE INVENTION

In view of the foregoing disadvantages inherent in the known types of tree hydrating devices now present in the prior art, the present invention provides a new tree hydrating device wherein the same can be utilized for providing convenience for the user when providing fluid to a tree for hydrating the same.

The tree hydrating device comprises a pouch having a hollow interior volume that is filled with a fluid capable of hydrating a tree. An elongated tube is connected to the pouch and is in fluid communication therewith. A tap having a hollow bore therethrough is provided and is adapted to be inserted into the trunk of a tree. The elongated tube can be connected to the tap via frictional fit so that fluid can be provided from the pouch, through the tube, through the tap, and directly into the tree where it can be absorbed thereby. In this way, the tree is provided with a constant source of hydration and can absorb the fluid supplied thereto as needed.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the tree hydrating device.

FIG. 2 shows a close-up view of the tap of the tree hydrating device.

FIG. 3 shows a frontal view of the tree hydrating device in use with a tree.

### DETAILED DESCRIPTION OF THE INVENTION

Reference is made herein to the attached drawings. Like reference numerals are used throughout the drawings to depict like or similar elements of the tree hydrating device. For the purposes of presenting a brief and clear description of the present invention, the preferred embodiment will be discussed as used for providing a constant source of hydration to a tree. The figures are intended for representative purposes only and should not be considered to be limiting in any respect.

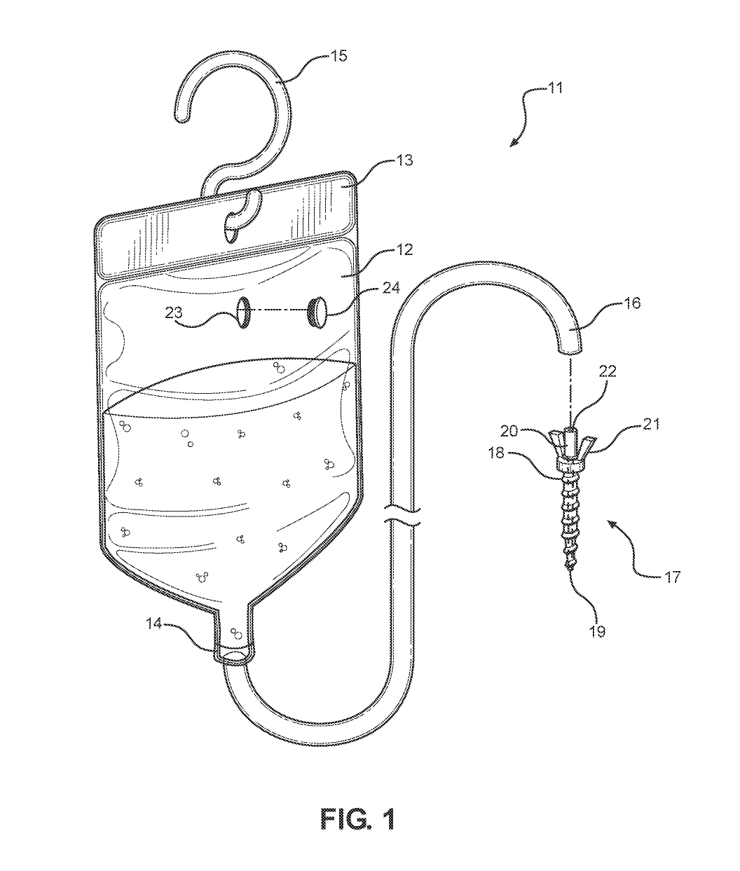

Referring now to FIG. 1, there is shown a perspective view of the tree hydrating device. The tree hydrating device 11 comprises a pouch 12 having an interior volume adapted to store a fluid therein, such as water, a nutrient enriched water, or a liquid fertilizer therein. The pouch 12 is prefilled with fluid or can be refillable depending upon the embodiment. In embodiments that are refillable, the pouch 12 includes an opening 23 thereon that is removably sealed by a plug 24. The plug 24 can be press fit to the opening 23 or can be secured thereto via threaded engagement as shown.

The pouch 12 includes an upper end 13 and a lower end 14. The upper end 13 is sealed and includes a fastener 15 thereon. In the illustrated embodiment, the fastener 15 is shown as a hook. The hook is adapted to be disposed over a branch on the tree or other similar support. In alternate embodiments, other suitable fasteners are used for securing the pouch 12 to a tree or nearby support structure. The lower end 14 of the pouch 12 includes an opening thereon for connection to an elongated tube 16 via frictional fit, threaded engagement, or other similar fastening method. Preferably, the pouch 12 tapers towards the lower end 14 thereof so that the fluid within the pouch 12 is funneled toward the opening on the lower end 14.

The elongated tube 16 comprises a first end and a second end, wherein the first end is removably secured to the lower end 14 of the pouch 12 via frictional fit, threaded engagement, or other fastening method. In this way, the elongated tube 16 can be changed or replaced if it is damaged. The second end of the elongated tube 16 is adapted to be removably secured to a tap 17 via frictional fit, threaded engagement, or other similar fastening methods, wherein the tap 17 is configured to be inserted into a trunk of a tree.

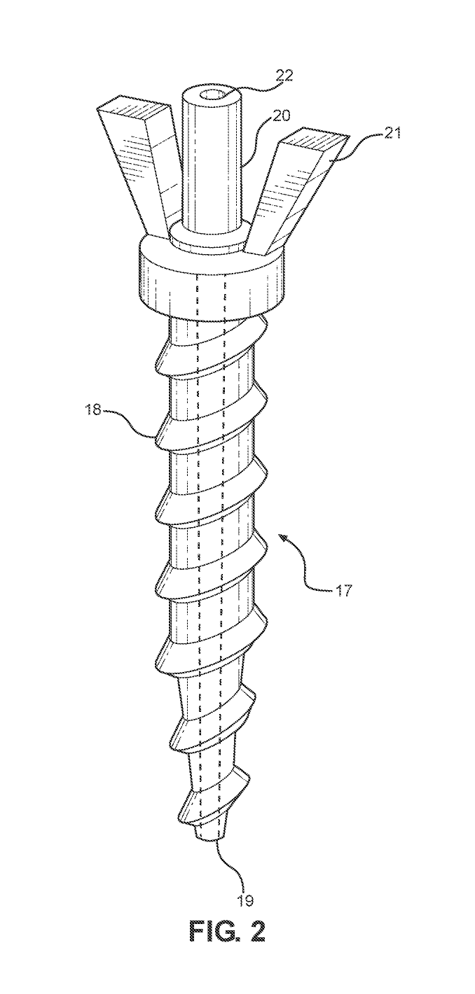

Referring now to FIG. 2, there is shown a close-up view of the tap of the tree hydrating device. The tap 17 comprises a body having a first end 20, a second end 19. Preferably, the body comprises external threading 18 thereon for facilitating insertion of the tap 17 into the tree trunk and for securely affixing the tap 17 within the tree trunk. The first end 20 of the tap 17 comprises a stem adapted to removably engage the elongated tube 16 so as to affix the tube 16 to the tap 17. Preferably, the stem is unthreaded so as to have smooth exterior surface. The second end 19 of the tap 17 tapers to a point to facilitate insertion of the tap 17 into the trunk of a tree. A hollow bore 22 extends from the first end 20 to the second end 19 of the tap 17 so as to allow fluid to flow therethrough and into the tree. The tap 17 further comprises a pair of wings 21 thereon that allow the user to rotate the tap 17 by hand as it is being inserted. As the user rotates the wings 21 in a circular motion, the tap 17 is driven further into the trunk of the tree due to the threading thereon. The wings 21 are sized so as to provide the user with a gripping surface and sufficient leverage to provide the force required to drive the tap 17 into the trunk of the tree.

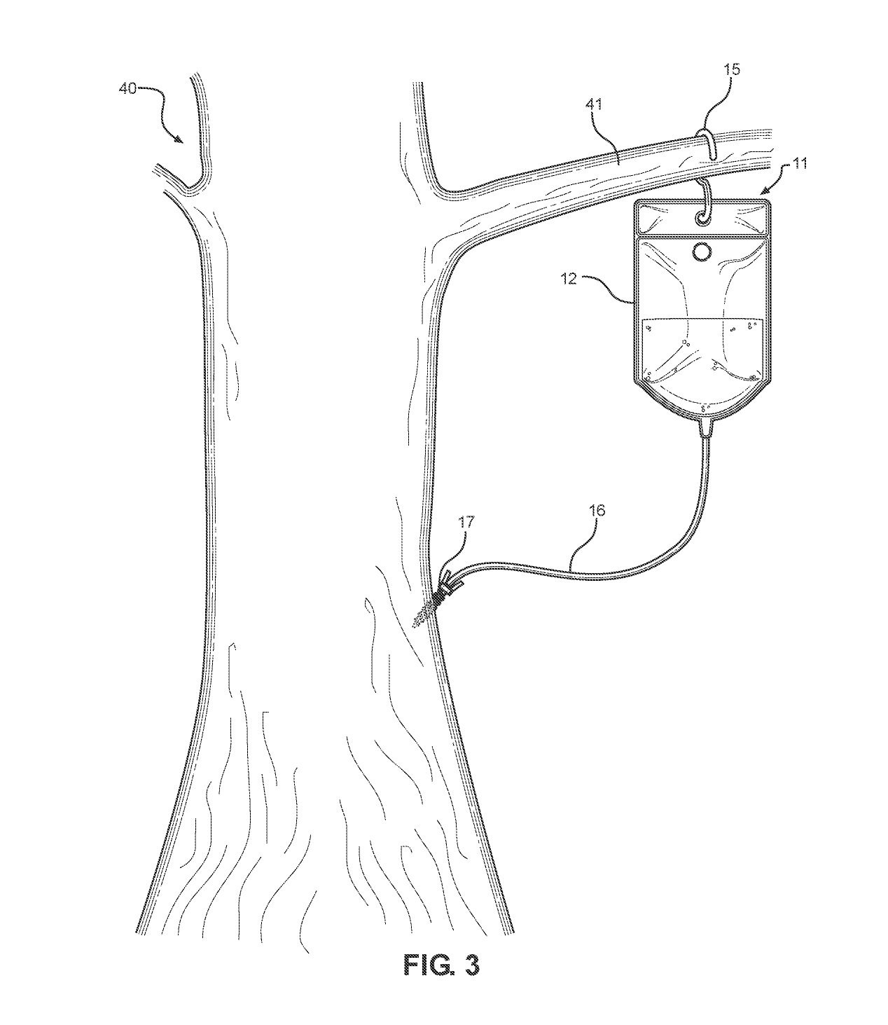

Referring now to FIG. 3, there is shown a frontal view of the tree hydrating device in use with a tree. In operation, a pouch 12 that has been filled with fluid is affixed to a branch 41 of a tree 40 or other similar support surface via the fastener 15 thereon. In this way, the pouch 12 is suspended from the branch 41 in a vertical orientation and can be easily positioned and replaced once the fluid from the pouch 12 has drained.

The tap 17 is inserted into a hole drilled into the trunk of the tree. The user can drill the hole using any conventional drill and bit, so long as the hole is of sufficient size and depth to receive the tap 17 therein. Preferably, the hole is drilled at a downward angle into the trunk of the tree. The hole is also drilled below the position of the branch on which the pouch 12 is suspended so as to allow for the fluid to drain therefrom via gravity. The tap 17 extends to a sufficient depth within the tree so as to allow for the tree to uptake and absorb the fluid from the pouch 12. Thus, the tap is preferably positioned so as to extend through the bark of the tree and into the sapwood thereof wherein the tree can uptake the fluid and nutrients.

The elongated tube 16 is attached at its first end to the lower end of the pouch 12, and the elongated tube 17 is connected at its second end to the tap 17. In this way, the fluid within the pouch 12 can flow from the pouch 12, through the tube 16, through the tap 17, and into the tree 40. The pouch 12 is disposed at an elevated location relative to the tap 17 so that the fluid from the pouch 12 is provided to the tap 17 under the force of gravity. In this way, the tree 40 is supplied with a continuous source of hydration. The rate of absorption by the tree 40 will also control the fluid flow from the pouch 12 through the elongated tube 16.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A tree hydrating device, comprising:
a pouch having an interior volume adapted to store a fluid therein;
an elongated tube having a first end and a second end, wherein the first end is in fluid communication with the pouch, and wherein the second end is removably affixed to a tap;
a tap adapted to be inserted into a tree, wherein the tap comprises a hollow bore therethrough.

2) The tree hydrating device of claim 1, further comprising a fastener disposed on the pouch and adapted to removably secure the pouch to a support structure.

3) The tree hydrating device of claim 2, wherein the fastener is a hook.

4) The tree hydrating device of claim 1, wherein the pouch tapers towards the lower end thereof.

5) The tree hydrating device of claim 1, wherein the tap comprises a threaded exterior so as to facilitate insertion of the tap into the tree.

6) The tree hydrating device of claim 1, wherein the tap comprises a pair of wings configured to allow the tap to be rotated by hand.

7) A method of a hydrating a tree, comprising the steps of:
providing a pouch having an interior volume in which a fluid is stored, wherein the pouch includes an elongated tube extending therefrom;
suspending the pouch from a branch of a tree;
inserting a tap having threading on the exterior thereof into a trunk of the tree;
affixing the elongated tube to the tap so that fluid within the pouch can flow through the tap and into the tree.

8) The method of claim 7, wherein the step of inserting a tap into a trunk of the tree further comprises the steps of:
drilling a hole in a trunk of the tree; and
positioning the tap within the hole in the trunk of the tree;
rotating the tap such that the exterior threading of the tap drives the tap into the trunk of the tree.

9) The method of claim 7, wherein the step of inserting a tap into a trunk of the tree further comprises the steps of:
inserting the tap into the trunk of the tree at a downward angle.
